(19) United States
(12) Patent Application Publication
(10) Pub. No.: US 2010/0260945 A1
(43) Pub. Date: Oct. 14, 2010

(54) SYSTEM AND METHODS FOR OPTICAL CURING USING A REFLECTOR

(75) Inventors: Andrew Kites, Brighton, MA (US); Robert F. Karlicek, JR., Chelmsford, MA (US)

Correspondence Address: LUMINUS DEVICES , INC.;C/O WOLF, GREENFIELD & SACKS , P.C., 600 ATLANTIC AVENUE, BOSTON, MA, 02210-2206, US

(73) Assignee: Luminus Devices, Inc., Billerica, MA (US)

(21) Appl. No.: 12/704,104

(22) Filed: Feb. 11, 2010

Related U.S. Application Data
(60) Provisional application No. 61/152,416, filed on Feb. 13, 2009.

(51) Int. Cl. B05D 3/06; F21V 7/00; F21V 7/08; F21V 1/00; F21V 9/00

(52) U.S. Cl. 427/553; 362/296.01; 362/296.06; 362/235; 362/231

(57) ABSTRACT

Systems and methods for curing a curable coating with electromagnetic radiation are provided. The system may include a reflector having a focusing reflective surface, a source focal region, and an object focal region. An array of UV LEDs may be positioned within the source focal region to emit an electromagnetic radiation toward the focusing reflective surface. The focusing reflective surface can reflect light emitted by the array of UV LEDs toward the curing surface located within the object focal region of the reflector.

### RELATED APPLICATIONS

This application claims priority to U.S. Provisional Patent Application Ser. No. 61/152,416, filed Feb. 13, 2009 which is incorporated herein by reference in its entirety.

### FIELD OF THE INVENTION

This invention relates to systems and methods for curing a curable coating with electromagnetic radiation. More specifically, embodiments of the present invention relate to a system for focusing electromagnetic radiation onto a curing surface. Even more specifically, embodiments of the present invention relate to a system for focusing electromagnetic radiation emitted by an array of UV LEDs onto a curing surface.

### BACKGROUND

Adhesives are used widely in many industries as an efficient means of joining two or more elements. In the electronics industry, adhesives are particularly used for supporting components on printed circuit boards. The inherent disadvantage of the use of adhesive is the time factor required for setting or curing the adhesive. This time problem has been solved to some extent by the use of electromagnetic radiation curing. Exposure to electromagnetic radiation, including the ultraviolet (UV) and infrared (IR) spectrums, promotes curing through polymerization, or cross-linking of monomers in the adhesive. In addition to a substantial saving of time, there is also a considerable saving in plant space, since an electromagnetic curing line is considerably shorter than previous systems, which for example, utilized heated gas ovens. Another advantage of electromagnetic curing is that there are no solvents to be discharged into the atmosphere.

One of the most efficient electromagnetic radiation curing systems employs a tubular quartz lamp which includes mercury and argon and produces a high temperature electric arc. The light emitted from the exited mercury plasma is in 360 degrees with respect to the longitudinal axis of lamp. Lamp may be positioned near a curing surface so as to project radiation thereon to effect curing. However, the majority of emitted radiation does not directly strike the curing surface. In order to focus the light into a uniform and narrow line of irradiance and capture substantial portion of the light required for curing UV-curable material, complex and large systems utilizing multiple reflectors and lenses have been used in the prior art. Such systems are not efficient due to loss of the escaped light not being fully focused by the optical elements. In addition, such systems require utilization of bigger reflectors and bulky cooling systems because of the heat generated by mercury lamps, and as a result, the weight of such systems limiting the speed of the curing apparatus. Moreover, curing systems utilizing mercury lamps do not allow placing a curing surface close to a reflector due to the nature of lamp illumination, which requires focusing optics to be placed far from the curing surface in order to capture more light emitted in 360 degrees from the mercury lamp. Another limitation is the heat generated by the mercury lamp: placing a lamp too close to a curing surface or to a reflector will result in overheating and deforming the curing surface or the reflector, or both. Higher curing system efficiency, or more complete use of emitted radiation, means less radiation needs to be emitted to effect curing. Higher curing system efficiency will result in less power required to effect curing of the adhesive on the curing surface. More efficient systems characterized by a highly uniform focused beam of irradiance are needed for efficient curing applications.

### SUMMARY OF THE INVENTION

Systems and methods for curing a curable coating with electromagnetic radiation are provided.

In one set of embodiments, a system for focusing electromagnetic radiation onto an illumination area is provided. The system includes a reflector having a focusing reflective surface, a source focal region, and an object focal region. The system further includes an electromagnetic radiation source for emitting electromagnetic radiation onto said illumination area; wherein said source of electromagnetic radiation is disposed at the source focal region, and the focusing reflective surface reflects an electromagnetic radiation toward the illumination area disposed at the object focal region.

In one set of embodiments, a system for focusing electromagnetic radiation onto an illumination area is provided. The system includes a first reflector having a first focusing reflective surface, a first source focal region, and a first object focal region. The system further includes a first electromagnetic radiation source for emitting electromagnetic radiation onto said illumination area; wherein said source of electromagnetic radiation is disposed at the first source focal region of the first reflector, and the first focusing reflective surface reflects an electromagnetic radiation toward said illumination area. The system further includes a second reflector having a second focusing reflective surface, a second source focal region, and a second object focal region. The system further includes a second source of electromagnetic radiation for emitting electromagnetic radiation onto said illumination area; wherein said source of electromagnetic radiation is disposed at the second source focal region of the second reflector, and the second focusing reflective surface reflects an electromagnetic radiation toward said illumination area.

In one set of embodiments, a method of curing an electromagnetic radiation-curable coating on a substrate using electromagnetic radiation is provided. The method comprises the steps of providing a coated substrate; locating an electromagnetic radiation reflector at a position spaced from said coated substrate; and positioning an electromagnetic radiation source between said coated substrate and said electromagnetic radiation reflector such that said rays being emitted by said source onto reflector and reflected onto said coated substrate.

Other aspects, embodiments and features of the invention will become apparent from the following detailed description of the invention when considered in conjunction with the accompanying figures. The accompanying figures are schematic and are not intended to be drawn to scale. In the figures, each identical or substantially similar component that is illustrated in various figures is represented by a single numeral or notation.

For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

The preceding summary, as well as the following detailed description of the invention, will be better understood when read in conjunction with the attached drawings. For the purpose of illustration the invention, presently preferred embodiments are shown in the drawings. It should be understood, however, that the invention is not limited to the precise arrangements and instrumentalities shown.

FIG. 1 depicts a schematic view of the radiation pattern of a conventional elongate UV lamp utilized in the prior art.

FIG. 2 depicts the reflection of rays toward a curing surface by an elliptical reflector utilized in the prior art.

FIG. 3 depicts a prior art embodiment where a pair of secondary curved reflectors are used to redirect rays back towards the primary reflector.

FIG. 4 depicts the embodiment of the present invention where one elliptical reflector is used to reflect light emitted by an array of UV LEDs onto a curing surface.

FIG. 5 depicts in more details the embodiment of the present invention where one elliptical reflector is used to reflect light emitted by an array of UV LEDs onto a curing surface; a better view of an array of UV LEDs mounted on a water-cooled substrate.

FIG. 6 is a schematic view of another embodiment of the present invention illustration an approximate distance between a source and object focal regions.

FIG. 7 depicts another embodiment of the present invention where one elliptical reflector is used to reflect light emitted by an array of UV LEDs onto a curing surface and two side reflectors are used at each longitudinal end of said elliptical reflector.

FIG. 8 depicts another embodiment of the present invention utilizing two elliptical reflectors with a shared object point.

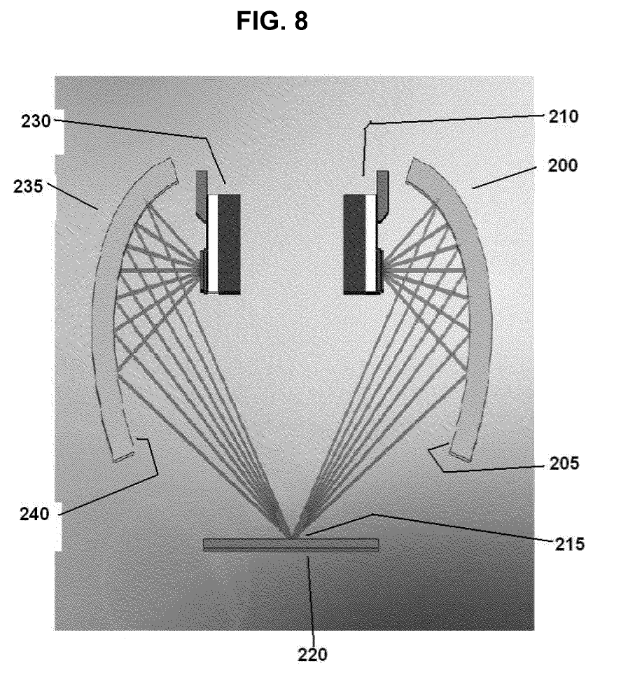

### DETAILED DESCRIPTION

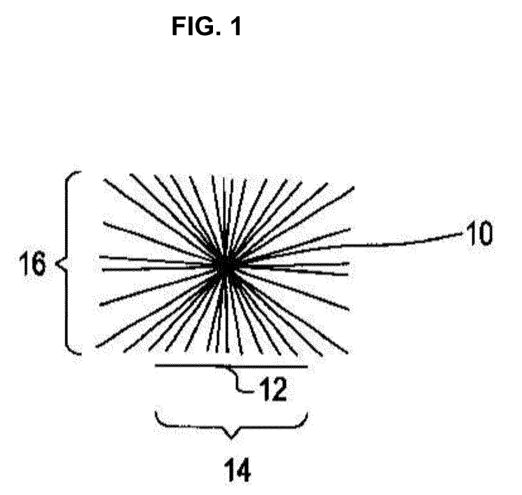

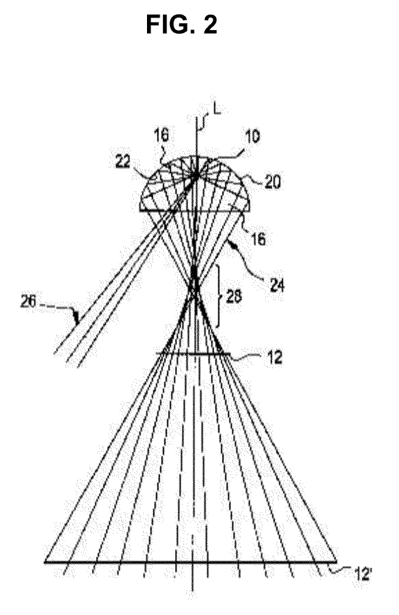

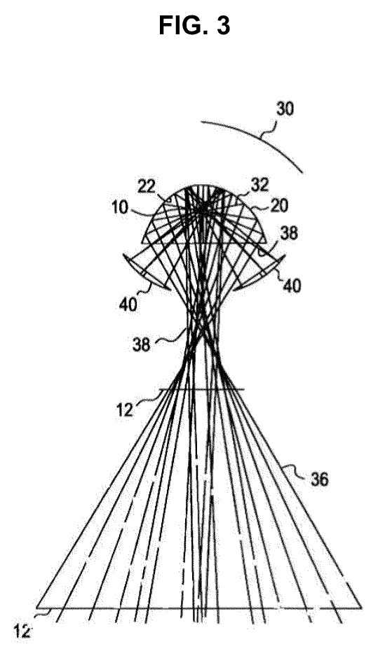

As shown in FIG. 1, a tubular quartz lamp 10 that produces the proper spectrum is generally cylindrical and emits light in 360 degrees with respect to the longitudinal axis of lamp 10, which could be positioned near a curing surface 12 so as to project radiation thereon to effect curing. It can be appreciated from FIG. 1 that the majority of emitted radiation does not directly strike the curing surface. The rays of illumination radiating from the lamp source can be generally characterized as one of two types, direct rays 14 and escape rays 16. Direct rays 14 are those rays from the lamp 10 that propagate directly onto curing surface 12. The intensity of the direct rays at the curing surface is affected by the distance between the curing surface and the lamp. The further curing surface 12 is located from lamp 10, the less intense will be the electromagnetic radiation formed by the direct rays 14. Escape rays 16 are those rays emitted by lamp 10 that do not directly strike curing surface. To capture some of the escape rays 16 by reflecting a portion thereof onto curing surface 12, an elongate elliptical reflectors have been used in the prior art. Referring to FIG. 2, lamp 10 is positioned within the expanse 18 of an elongate elliptical primary reflector 20 having an inner reflective surface 22 so that a portion of the escape rays 16 are reflected towards curing surface 12 after being reflected off elliptical reflective surface 22. It must be noted, that not all of the escape rays 16 are reflected off of reflective surface 22, however, thus some of the escape rays 16 will still not strike curing surface 12, either directly or by reflection. In another example of the prior art depicted in FIG. 3, a pair of secondary curved reflectors 30 positioned adjacent lamp 10 and primary reflector 20 in order to direct back some additional portion of the evasive rays 38 emitted by lamp 10 to primary reflective surface 22 for redirection onto the curing surface 12. It is very challenging to achieve the required for curing high intensity and narrow line irradiation by utilizing described above prior art embodiments. In order to redirect the escaped light back to the curing surface, the reflectors must be positioned far from the curing surface, which in turn leads to lower intensity radiation received by the curing surface. Another limitation is the heat emitted by the lamp which could damage or deform a curing surface as well as reflector. As a result, the prior art optical curing systems are characterized by low efficiency and bulky designs requiring elaborate optics to redirect the light, as well as the bulky cooling systems to cool the parts heated up by UV lamps.

The following embodiments of the proposed invention are designed to solve mentioned above problems associated with the prior art optical systems for curing by utilizing an array of light emitting devices (LEDs) emitting light in about 120 degrees in case of Lambertian emission LEDs, and in about 80 degrees in case of collimating emission LEDs, resulting in the optical systems characterized by high efficiency, uniform narrow-line high intensity irradiance, and compact designs without need to employ an elaborate optical and bulky cooling systems.

Some embodiments involve maximizing the intensity of electromagnetic spectrum emitted by a radiation source during the process of curing an adhesive by utilizing an array of LEDs and reflector and to provide an apparatus for curing an adhesive on a curing surface of varying dimensions.

In some embodiments, the proposed invention utilizes an array of LEDs instead of mercury lamp as a source of electromagnetic radiation. The light emitted form a Lambertian emission LED is in approximately 120 degrees, and is in approximately 80 degrees in case of an LED having a collimating emission characteristic. Only one reflector may be needed to effectively focus the light from an LED array into a uniform and narrow line of irradiance utilizing a Lambertian emission LED; more compact reflector may be needed in case of an LED with collimating emission. Two reflectors with shared object focal point could be used to double the intensity of irradiation. The width of irradiance line is controlled by optimizing the reflector, i.e. the distance between a reflective surface, a source focal region, and an object focal region. The following are examples of advantage of the proposed invention over prior art: no need for collection optics such as light pipes or the need for a focusing lens, elimination of a bulky cooling system for a reflector, more efficient system with highly uniform focused beam of irradiance, smaller size of reflector, ability to focus the light into the narrow line while maintaining close proximity of curing surface and the reflector resulting in a much more compact design.

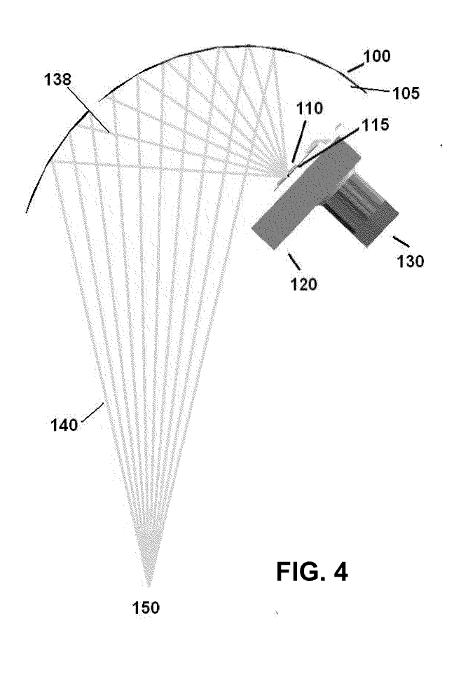

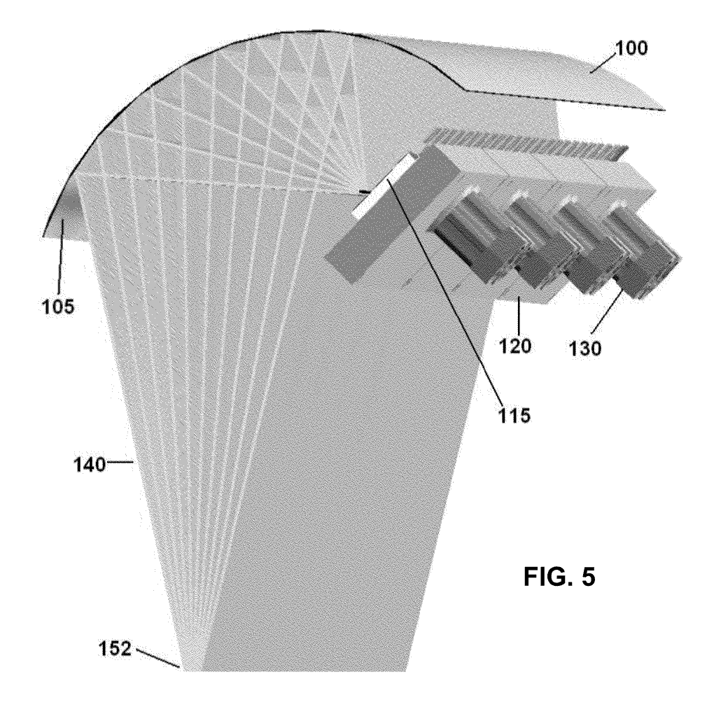

Referring to FIGS. 4-5, a preferred embodiment of the present invention is illustrated. An elliptical reflector 100 having a reflective surface 105, a source focal region 110 and an object focal region 150 is depicted in FIG. 4, where an array of UV LEDs mounted on a water-cooled substrate 120 is positioned at the source focal region 110 of an elliptical reflector 100. A water-cooling system 130 is employed to dissipate the heat generated by an array of UV LEDs 115. The rays 138 are emitted by an array of UV LEDs 115 toward the reflective surface 105 of an elliptical reflector 100 from where they are reflected toward an object focal region forming a highly uniform focused beam of irradiance. As shown in FIG. 4, most of the electromagnetic radiation emitted from an array of LEDs is focused onto the curing surface without loss of any significant portion of light. Thus, the preferred embodiment of the present invention is optimized in such a way as to make maximum use of all the radiation emitted by an array of UV LEDs 115 having a Lambertian emission, and even more so in case of collimating emission UV LEDs. It should be noted that the water-cooling system 130 could be replaced by an air cooling system without any perceptible qualitative loss. Furthermore, it is contemplated that the primary reflector may have a shape other than elliptical, which would require the present invention be arranged to optimize the curing characteristics provided by the reflector design. Furthermore, it is contemplated that the reflective surface 105 of the elliptical reflector could be optimized to produce a highly uniform line of irradiance by modifying the surface roughness.

FIG. 5 is a more detailed illustration of the curing system depicted in FIG. 4. In particular, it shows an electromagnetic radiation focused into a highly uniform and narrow line of irradiance 152. Such a narrow line of irradiance characterized by high intensity electromagnetic radiation is a result of an optimized curing system of the present invention, which utilizes an elliptical reflector and an array of UV LEDs with Lambertian or collimating emission patterns. It should be understood that the terms “object focal region” or “source focal region,” in addition to referring to the foci of an ellipse, also mean in the context of a generalized reflector the position of the light source (object focal region) and the location where the light rays are focused (object focus), without regard to the actual geometry of the reflector.

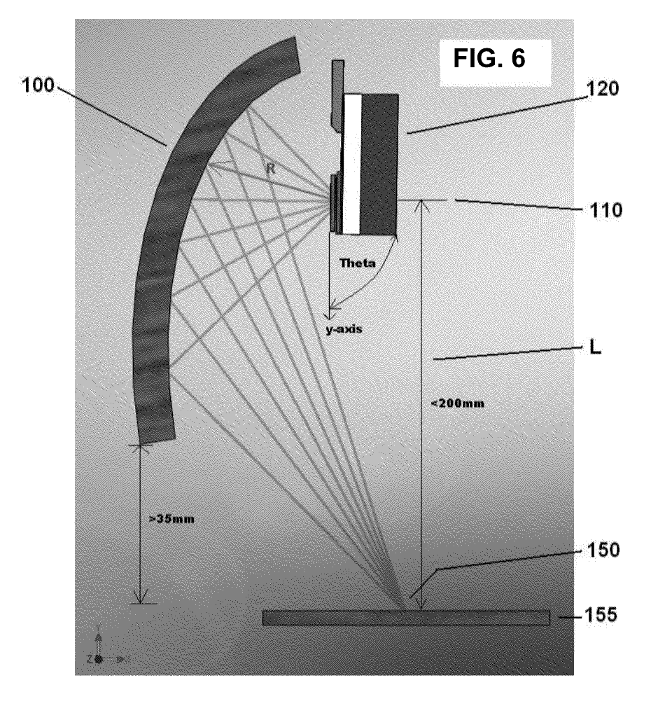

FIG. 6 illustrates another embodiment of the present invention where curing surface 155 is positioned at the object focal region 150 of an elliptical reflector 100 in such a way that the distance L between the source focal region 110 and the object focal region 150 is less than 200 millimeters. The resulted compact configuration of the curing system with efficient capturing of significant portion of light is attributed to the application of UV LEDs, which could be Lambertian or collimating LEDs, emitting light in approximately 120 and 80 degrees, respectively. In comparison with the mercury lamp emitting UV radiation, the light emitted by a Lambertian emission UV LED is much easier to focus without employing an elaborate optics and without need to place the curing surface far from the source focal region. It should be appreciated that the present invention may utilize an array of UV LEDs with the surface area greater than 1 square millimeter.

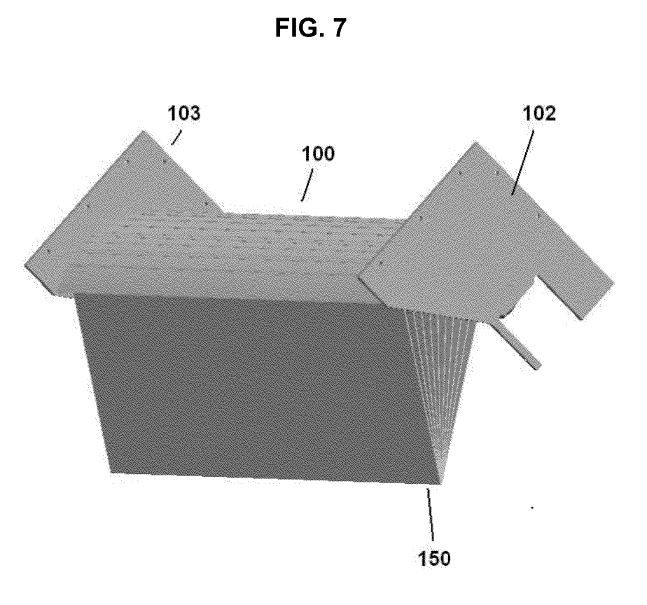

FIG. 7 illustrates an additional feature of the present invention. In addition to the radially emitted direct rays, an array of UV LEDs further emits rather small portion of end escape rays, which project generally diagonally out form the longitudinal ends of an elliptical reflector. The preferred embodiment of the present invention includes two side reflectors 102 and 103 located at each longitudinal end of an elliptical reflector 100. Similarly to an elliptical reflector 100, the side reflectors 102 and 103 redirect end escape rays back towards curing surface located at the object focal region 150. It is contemplated that the side reflectors 102 and 103 may have a shape other than elliptical, which would require the present invention be arranged to optimize the curing characteristics provided by the reflector design.

FIG. 7 depicts schematically the curing system comprising two elliptical reflectors 200 and 235. Both reflectors have a shared object focal region 215. The curing surface 220 is positioned at the shared by two reflectors object focal region 215. Such a configuration allows doubling the intensity of UV radiation emitted by an array of UV LEDs and results in a more efficient curing system without sacrificing materially the size of the system. It is contemplated that any one reflector or both reflectors may have a shape other than elliptical. Even though the reflective characteristic of such other reflectors are less efficient for reflecting radiation onto a curing surface, nevertheless, the present invention would still be arranged to optimize the curing characteristics provided by the reflector design. It should be appreciated that the present invention may utilize an array of UV LEDs with the surface area greater than 1 square millimeter.

Any suitable LEDs may be used in connection with the invention. Examples of suitable LEDs have been described, for example, in U.S. Pat. Nos. 6,831,302 and 7,417,367 which are incorporated herein in their entireties.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A system for focusing electromagnetic radiation onto an illumination area comprising:
a reflector having a focusing reflective surface, a source focal region, and an object focal region;
an electromagnetic radiation source for emitting electromagnetic radiation onto said illumination area; wherein said source of electromagnetic radiation is disposed at the source focal region, and the focusing reflective surface reflects an electromagnetic radiation toward the illumination area disposed at the object focal region.

2. The system of claim 1, wherein a focusing reflective surface is either generally elliptical, parabolic, spherical, concave, hyperbolic, or comprising compound shapes.

3. The system of claim 1, wherein a focusing reflective surface is made of specialized reflecting material.

4. The system of claim 1, wherein said source of electromagnetic radiation is a light-emitting diode (LED) array comprising a plurality of LEDs mounted on a substrate; wherein said substrate is either a water-cooled substrate or an air-cooled substrate.

5. The system of claim 1, wherein said source of electromagnetic radiation is a light-emitting diode (LED) array comprising a plurality of LEDs; wherein each of the plurality of LEDs is an LED from the group of Red LED, Green LED, Blue LED, White LED, Amber LED, and UV LED.

6. The system of claim 1, wherein said source of electromagnetic radiation is a light-emitting diode (LED) array comprising a plurality of LEDs; wherein each of the plurality of LEDs is an LED having the surface area greater than 1 square millimeter.

7. The system of claim 1, wherein said source of electromagnetic radiation is a light-emitting diode (LED) array comprising a plurality of LEDs; wherein each of the plurality of LEDs is an LED with substantially Lambertian emission.

8. The system of claim 1, wherein said source of electromagnetic radiation is a light-emitting diode (LED) array comprising a plurality of LEDs; wherein each of the plurality of LEDs is an LED with substantially collimating emission.

9. The system of claim 1, wherein said reflector comprising further a pair of side reflectors which are either generally elliptical, parabolic, spherical, concave, or hyperbolic, or comprising compound shapes.

10. The system of claim 1, wherein said reflector is configured such that the distance between a source focal region and an object focal region is less than 200 millimeters.

11. A system for focusing electromagnetic radiation onto an illumination area comprising:
a first reflector having a first focusing reflective surface, a first source focal region, and a first object focal region;
a first electromagnetic radiation source for emitting electromagnetic radiation onto said illumination area; wherein said source of electromagnetic radiation is disposed at the first source focal region of the first reflector, and the first focusing reflective surface reflects an electromagnetic radiation toward said illumination area;
a second reflector having a second focusing reflective surface, a second source focal region, and a second object focal region;
a second source of electromagnetic radiation for emitting electromagnetic radiation onto said illumination area; wherein said source of electromagnetic radiation is disposed at the second source focal region of the second reflector, and the second focusing reflective surface reflects an electromagnetic radiation toward said illumination area.

12. The system of claim 11, wherein said illumination area is disposed at the first and second object focal regions; wherein said first and second object focal regions are spaced apart from each other.

13. The system of claim 11, wherein said illumination area is disposed at the first and second object focal regions; wherein said first and second object focal regions substantially overlap each other.

14. The system of claim 11, wherein said first reflective surface is either generally elliptical, parabolic, spherical, concave, hyperbolic, or comprising compound shapes.

15. The system of claim 11, wherein said first focusing reflective surface is made of specialized reflecting material.

16. The system of claim 11, wherein said second reflective surface is either generally elliptical, parabolic, spherical, concave, hyperbolic, or comprising compound shapes.

17. The system of claim 11, wherein said second focusing reflective surface is made of specialized reflecting material.

18. The system of claim 11, wherein both said first and second source of electromagnetic radiation are light-emitting diode (LED) arrays comprising a plurality of LEDs mounted on a substrate; wherein said substrate is either a water-cooled substrate or an air-cooled substrate.

19. The system of claim 11, wherein both said first and second source of electromagnetic radiation are light-emitting diode (LED) arrays comprising a plurality of LEDs; wherein each of the plurality of LEDs is an LED from the group of Red LED, Green LED, Blue LED, White LED, Amber LED, and UV LED.

20. The system of claim 11, wherein said source of electromagnetic radiation is a light-emitting diode (LED) array comprising a plurality of LEDs; wherein each of the plurality of LEDs is an LED having the surface area greater than 1 square millimeter.

21. The system of claim 11, wherein both said first and second source of electromagnetic radiation are light-emitting diode (LED) arrays comprising a plurality of LEDs; wherein each of the plurality of LEDs is an LED with substantially Lambertian emission.

22. The system of claim 11, wherein both said first and second source of electromagnetic radiation are light-emitting diode (LED) arrays comprising a plurality of LEDs; wherein each of the plurality of LEDs is an LED with substantially collimating emission.

23. The system of claim 11, wherein said first and second reflector each comprising further a pair of side reflectors which are either generally elliptical, parabolic, spherical, concave, or hyperbolic, or comprising compound shapes.

24. The system of claim 11, wherein said first reflector is configured such that the distance between said first source focal region and said first object focal region is less than 200 millimeters; and wherein said second reflector is configured such that the distance between said second source focal region and said second object focal region is less than 200 millimeters.

25. A method of curing an electromagnetic radiation-curable coating on a substrate using electromagnetic radiation, said method comprising the steps of:
providing a coated substrate;
locating an electromagnetic radiation reflector at a position spaced from said coated substrate;
positioning an electromagnetic radiation source between said coated substrate and said electromagnetic radiation reflector such that said rays being emitted by said source onto reflector and reflected onto said coated substrate.
